(19) United States
(12) Patent Application Publication
(10) Pub. No.: US 2025/0085566 A1
(43) Pub. Date: Mar. 13, 2025

(54) GOGGLE STRUCTURE HAVING FLIP-UP FUNCTION AND CAPABLE OF COVERING EYEGLASSES

(71) Applicant: OURAD SAFETY CO., LTD., TAINAN CITY (TW)

(72) Inventor: PIN-TSUNG HUANG, TAINAN CITY (TW)

(21) Appl. No.: 18/463,547

(22) Filed: Sep. 8, 2023

(51) Int. Cl. G02C 1/04; G02C 5/12; G02C 5/20; G02C 9/04

(52) U.S. Cl. CPC G02C 1/04; G02C 5/122; G02C 5/20; G02C 9/04; G02C 2200/08

(57) ABSTRACT

A goggle structure having a flip-up function and capable of covering eyeglasses includes a first lens, a second lens, two temple units, and two soft sealing pads. The first lens has two lateral sides each provided with a first coupling portion and extended with a transparent lateral window portion. The second lens is pivotally connected to the first lens. Each temple unit includes an adapter block that is rotatable leftward and rightward with respect to the first lens and a temple that is rotatable upward and downward with respect to the adapter block. The soft sealing pads are detachably coupled to the first lens. The inner side of the first lens defines an accommodating space for accommodating the eyeglasses the user wears in the first place, with the first lens covering the eyeglasses, so the user can wear the goggles as well as the eyeglasses during work or other activities.

### BACKGROUND OF THE INVENTION

### 1. Technical Field

The present invention relates to a goggle structure that is assembled by engagement between corresponding structures, that is not held together by metal screws or elastic elements, and that can cover a pair of eyeglasses with any common eyeglass frame.

### 2. Description of Related Art

3C products (i.e., computers, communication devices, and consumer electronics) abound in our daily lives, but using those products, in particular watching the contents displayed on their screens, over an extended period of time tends to impair eyesight or even cause damage to the eyes. This may explain why more and more people wear eyeglasses for vision correction. Besides, one who is performing a medical procedure, carrying out a soldering or grinding operation, doing sports, taking part in a racing competition, or simply feeling the need to shield their eyes from the sun may wear a pair of goggles to protect their eyes from injury. If they wear eyeglasses in the first place, they would have to choose goggles that have a relatively large accommodating space for accommodating, and can cover, eyeglasses with different common eyeglass frames, so they can wear the goggles as well as their eyeglasses during work or other activities. Currently, the pivotal connection elements used between the lens and temples of a pair of goggles are generally metal screws or elastic elements. Such metal screws or elastic elements nevertheless require a complicated and time-consuming locking operation and have a relatively great weight that makes it impossible to reduce the weight of the goggles. Moreover, such metal screws or elastic elements are likely to conduct electricity and may therefore raise occupational safety concerns, posing a danger to those wearing goggles during work.

In view of this, Taiwan Utility Model U.S. Pat. No. 416,303, published on Dec. 21, 2000, and entitled “GOGGLES,” discloses a pair of goggles that includes an eye-covering member and a lens holder. The eye-covering member has a front frame whose front-end top side is provided with two engaging bases that protrude upward. Each of the two engaging bases has two lateral sides each provided with a laterally protruding engaging rod, and an upwardly extending separation plate is provided between the two engaging bases. The lens holder has a top end provided with two grooves each corresponding to one of the two engaging bases. Each groove has two lateral portions configured as a notch portion and a hole portion. A slide groove is provided between the two grooves and is in the hole-portion side of one of the grooves. The lens holder is further provided with a recess and a forwardly extending inclined groove, both corresponding to the separation plate. Each of the two grooves of the lens holder can receive the corresponding one of the two engaging bases, and the separation plate can slide into the recess through the slide groove and be engaged in the recess such that the lens holder is pivotally engaged with an upper part of the eye-covering member. This goggle structure can be easily assembled, is suitable for use in oxy-fuel welding and cutting, and has industrial applicability.

The goggles disclosed in the '303 patent, however, are held together by metal screws or elastic elements, which have electrical hazards when the goggle user wears the goggles during work or other activities. In other words, the goggles may raise occupational safety concerns and cannot ensure the user's safety.

Taiwan Utility Model Patent No. M636064, published on Jan. 1, 2023, and entitled “TURNING AND POSITIONING STRUCTURE FOR FLIP-UP AUXILIARY LENS ASSEMBLY,” discloses a turning and positioning structure that includes a main-function lens assembly, an auxiliary lens assembly, and a supporting pivot-shaft member. The supporting pivot-shaft member is fastened to an upper side of the main-function lens assembly, and each of the two lateral sides of the supporting pivot-shaft member is extended with a supporting portion whose periphery is defined by a plurality of flat surfaces. Two spaced-apart connecting sections protrude from the peripheral edge of one side of the auxiliary lens assembly and are each formed with a polygonal recess. The connecting sections can be rotated upward and downward along the supporting portions of the supporting pivot-shaft member and be temporarily secured at a desired angular position by the supporting portions.

Each of the left and right sides of the main-function lens assembly in the '064 patent, however, has a closed portion where a temple is pivotally connected to the main-function lens assembly. The closed portions are opaque and will therefore reduce the user's field of view, if not hindering the user's work or activity. Furthermore, the closed portions cannot be removed to improve ventilation, so the lenses of the main-function lens assembly tend to be fogged up with hot air when the eyeglasses are worn continuously for a long time or worn under high temperature, leaving the user with a blurred view. In addition, the angle through which the temples can be rotated with respect to the lenses cannot be adjusted according to the size of the user's face, which leaves much to be desired in terms of use.

### BRIEF SUMMARY OF THE INVENTION

In view of the foregoing drawbacks of the conventional flip-up goggles/eyeglasses, the present invention provides a goggle structure having a flip-up function and capable of covering eyeglasses. The goggle structure includes a first lens, a second lens, two temple units, and two soft sealing pads. The first lens is provided with a first pivotal connection portion. The first lens has two lateral sides each provided with a first coupling portion. The two lateral sides of the first lens are each extended with a transparent lateral window portion, and each lateral window portion is provided with a first snap-fit portion. The first lens has an inner side defining an accommodating space. The second lens is provided with a second pivotal connection portion. The second pivotal connection portion is pivotally connected to the first pivotal connection portion such that the second lens can be flipped open with respect to the first lens. The two temple units are each coupled to the corresponding one of the two lateral sides of the first lens. Each temple unit includes an adapter block and a temple. Each adapter block is provided at one end with a second coupling portion for coupling with the corresponding first coupling portion so that each adapter block can be rotated to the left and to the right with respect to the first lens. Each adapter block is provided with an insertion groove at the opposite end, and each temple is provided with an insertion plate at one end. The insertion plate of each temple is inserted into the insertion groove of the corresponding adapter block to produce a position-limiting effect while allowing the temple to be rotated upward and downward with respect to the corresponding adapter block. The two soft sealing pads are detachably coupled to the first lens. Each soft sealing pad is provided with a second snap-fit portion for forming a snap-fit connection with the corresponding first snap-fit portion.

The first pivotal connection portion is provided at a middle portion of the first lens, and the second pivotal connection portion is provided at a middle portion of the second lens.

Each first coupling portion has an upper side and a lower side that are each provided with a first engaging hole along a vertical direction, and each second coupling portion has an upper side and a lower side that are each provided with a first engaging block along the vertical direction. The two first engaging blocks of each second coupling portion are each engaged in the corresponding one of the two first engaging holes of the corresponding first coupling portion.

Each first coupling portion is provided with a protruding plate between the two first engaging holes of the first coupling portion, and each second coupling portion is provided with a groove in the middle. The groove of each second coupling portion is configured to receive and confine the protruding plate of the corresponding first coupling portion.

Each first snap-fit portion is provided with a plurality of snap-fit blocks, and each second snap-fit portion is provided with a plurality of snap-fit holes. The snap-fit blocks of each first snap-fit portion are each snap-fitted in the corresponding one of the snap-fit holes of the corresponding second snap-fit portion.

The first lens and the temple units are made of plastic and are put together by engagement between corresponding structures, so there is no need to use metal screws or elastic elements to hold the first lens and the temple units together.

The second lens may be a protective lens for use in a medical environment, an eye-protecting lens for use in an industrial environment, a sun-blocking lens like those of sunglasses, a lens for vision correction (e.g., for correcting nearsightedness), or a sports lens for use in a sports activity. The accommodating space is configured to accommodate a pair of eyeglasses such that the pair of eyeglasses is covered by the first lens.

Each insertion groove has two lateral walls that are each provided with a second engaging hole along a horizontal direction, and each insertion plate has two lateral sides that are each provided with a second engaging block along the horizontal direction. The second engaging blocks of each insertion plate are each engaged in the corresponding second engaging hole of the corresponding insertion groove.

Each insertion groove is provided therein with a toothed rack section along the vertical direction, and each insertion plate has an end portion provided with a toothed block. The toothed block of each insertion plate meshes with the toothed rack section of the corresponding insertion groove.

Each first snap-fit portion is provided on a lateral side and a bottom portion of the corresponding lateral window portion, and each second snap-fit portion is provided on a lateral side and a bottom portion of the corresponding soft sealing pad.

The foregoing technical features have the following advantages:

1. The relatively large accommodating space provided on the inner side of the first lens can accommodate a pair of eyeglasses that the user wears in the first place, with the first lens covering the eyeglasses. More specifically, the accommodating space can accommodate eyeglasses with different-sized eyeglass frames, including eyeglasses with a thick eyeglass frame, eyeglasses with a thin eyeglass frame, and frameless eyeglasses. A pair of goggles using the goggle structure of the present invention (hereinafter referred to as the goggles) will not cause compression-related discomfort to its wearer and is therefore suitable for being worn while the wearer is working or is engaging in other activities.

2. As the first lens and the temple units are made of plastic and are put together by engagement between corresponding male and female engaging structures, there is no need to hold the first lens and the temple units together with metal screws or elastic elements. This allows the weight of the goggles to be reduced in comparison with their prior art counterparts so that a lightweight design can be attained.

3. Since no metal screws or elastic elements are required to hold the goggles together, electrical hazards associated with the use of metal screws or elastic elements do not exist when someone wears the goggles during work or other activities. The present invention, therefore, ensures the safety of a user of the goggles by reducing occupational safety accidents that may result from inadvertent electrical conduction through such metal screws or elastic elements.

4. The second lens can be chosen from a range of lenses that have different functions, in order to suit different work environments or activity venues. For example, the second lens may be a protective lens for use in a medical environment, an eye-protecting lens for use in an industrial environment, a sun-blocking lens like those of sunglasses, a lens for vision correction (e.g., for correcting nearsightedness), or a sports lens for use in a sports activity.

5. Each temple can be adjusted, i.e., rotated, in stages in a vertical direction with respect to the first lens according to the size of the user's face. This makes it possible for the goggles to adapt to the shape of the user's face so as not to get loose or fall off.

6. The soft sealing pads are configured to be in close contact with those areas of the user's face that are on the outer lateral sides of, and below, the user's eyes in order to keep foreign objects from flying into the goggles while the user is working, or prevent a patient's body fluid, bacteria, or virus from reaching the user's eyes through a gap between the goggles and the user's face while the user is performing a medical operation, the objective being to preclude injury in an industrial environment or infection in a medical environment.

7. The softness of the soft sealing pads adds to the comfort of wear, the tightness of wear, and the anti-slip effect of the goggles so that the goggles can be worn for a long time without causing discomfort or becoming a burden.

8. The soft sealing pads are coupled to the first lens in a detachable manner and therefore can be removed when no longer needed. Removal of the soft sealing pads helps increase ventilation in the goggles while the goggles are being worn, and this in turn prevents the goggles from being fogged up with hot air, and thus becoming blurred, when the goggles are worn for an extended period of time or under a high temperature.

9. The lateral window portions on the left and right sides of the first lens are transparent such that the see-through area of the goggles is larger than that of goggles with opaque portions on the lateral sides. Instead of hindering the user from doing their work or activity, the transparent lateral window portions contribute to providing the user with a large field of view.

### BRIEF DESCRIPTION OF THE SEVERAL VIEWS OF THE DRAWINGS

FIG. 1 is an exploded perspective view of an embodiment of the present invention.

FIG. 2 is an assembled perspective view of the embodiment in FIG. 1.

FIG. 3 is an enlarged view of portion III in FIG. 1.

FIG. 4 is a sectional view taken along line IV-IV in FIG. 2.

FIG. 5 is a sectional view taken along line V-V in FIG. 2.

FIG. 6 is another exploded perspective view of the embodiment in FIG. 1, showing in particular the soft sealing pads detached from the first lens.

FIG. 7 is another assembled perspective view of the embodiment in FIG. 1, showing in particular the soft sealing pads coupled to the first lens.

FIG. 8 shows how the embodiment in FIG. 1 can be used together with a pair of eyeglasses that the user wears in the first place.

FIG. 9 shows the embodiment in FIG. 1 worn on the user's face together with a pair of eyeglasses.

FIG. 10 is similar to FIG. 9 except that the second lens is flipped up.

FIG. 11 shows how each temple of the embodiment in FIG. 1 can be rotated upward and downward with respect to the corresponding adapter block.

### DETAILED DESCRIPTION OF THE INVENTION

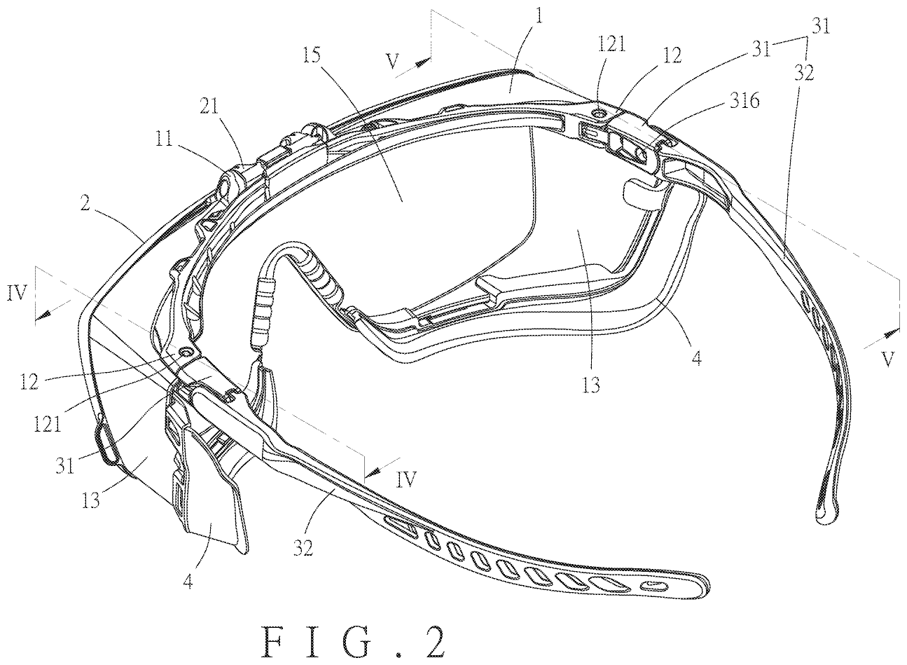

As used herein in connection with the embodiment described below, directional terms such as left, right, front, rear, upper, and lower make reference to the orientations of the goggles in FIG. 2. Those directional terms are used only to facilitate description of the embodiment and are not intended to limit the spatial aspects of the present invention.

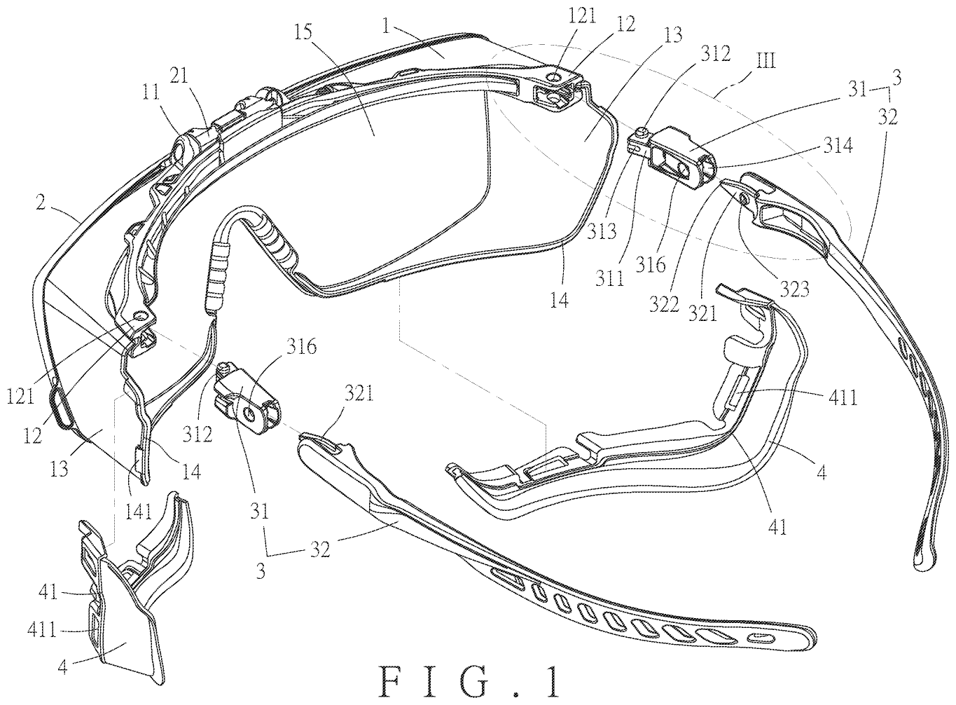

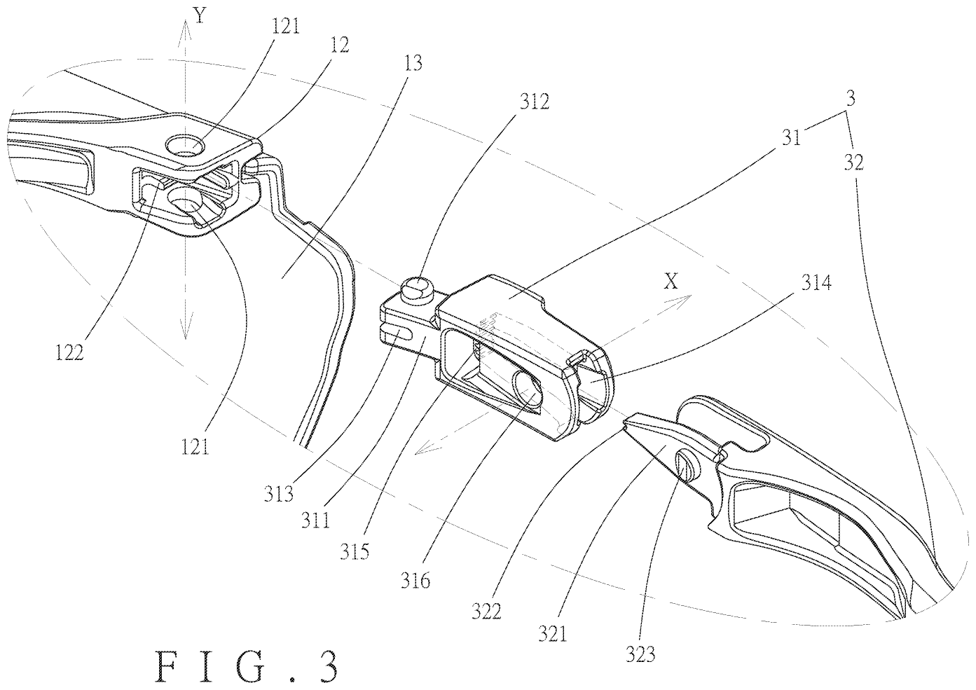

Referring to FIG. 1, FIG. 2, and FIG. 3, one embodiment of the present invention includes a first lens 1, a second lens 2, temple units 3, and soft sealing pads 4.

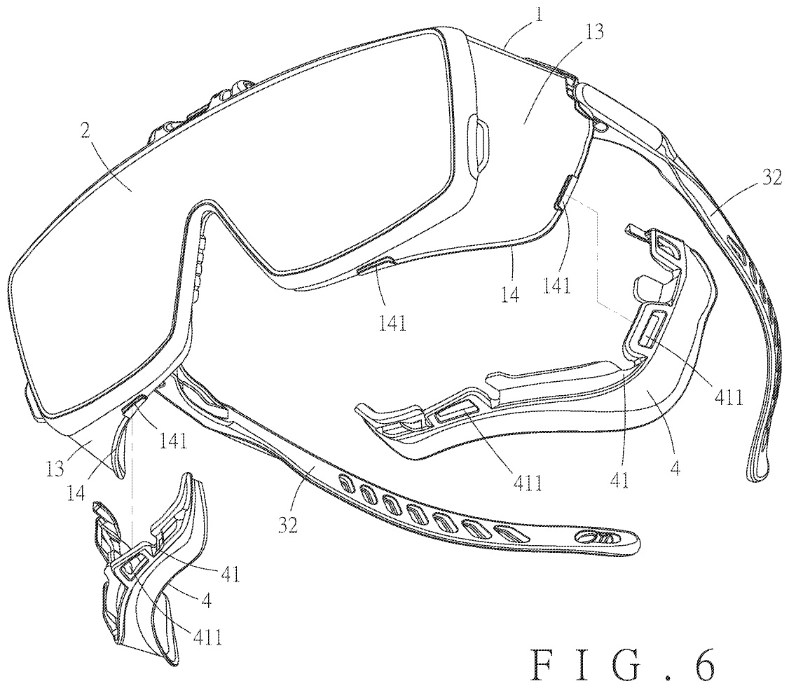

The first lens 1 has a middle portion provided with a first pivotal connection portion 11. An upper part of each of the two lateral sides of the first lens 1 is provided with a first coupling portion 12. Each first coupling portion 12 has an upper side and a lower side each provided with a first engaging hole 121 along a vertical direction Y. Each first coupling portion 12 is provided with a protruding plate 122 between the corresponding two first engaging holes 121. In addition, each of the two lateral sides (i.e., left and right sides) of the first lens 1 is extended with a transparent lateral window portion 13. Each lateral window portion 13 is provided with a first snap-fit portion 14 along a lateral side and a bottom portion of the lateral window portion 13, and each first snap-fit portion 14 is provided with a plurality of snap-fit blocks 141 (see FIG. 6). The inner side of the first lens 1 defines a relatively large accommodating space 15 for accommodating a pair of eyeglasses with any of various common eyeglass frames that may be different in size (e.g., a pair of eyeglasses with a thick eyeglass frame, a pair of eyeglasses with a thin eyeglass frame, or a pair of frameless eyeglasses), with the first lens 1 covering the pair of eyeglasses. The first lens 1 is configured to accommodate and cover any eyeglasses the user wears, so the user will not have problem wearing the goggles together with, or putting on the goggles while wearing, a different pair of eyeglasses. Rather, the user will be able to put on the goggles conveniently and wear them along with a pair of eyeglasses of the user's choice during work or other activities.

The second lens 2 has a middle portion provided with a second pivotal connection portion 21. The second pivotal connection portion 21 is pivotally connected to the first pivotal connection portion 11 so that the second lens 2 can be flipped open with respect to the first lens 1. The second lens 2 may be a protective lens for use in a medical environment, an eye-protecting lens for use in an industrial environment, a sun-blocking lens like those of sunglasses, a lens for vision correction (e.g., for correcting nearsightedness), or a sports lens for use in a sports activity.

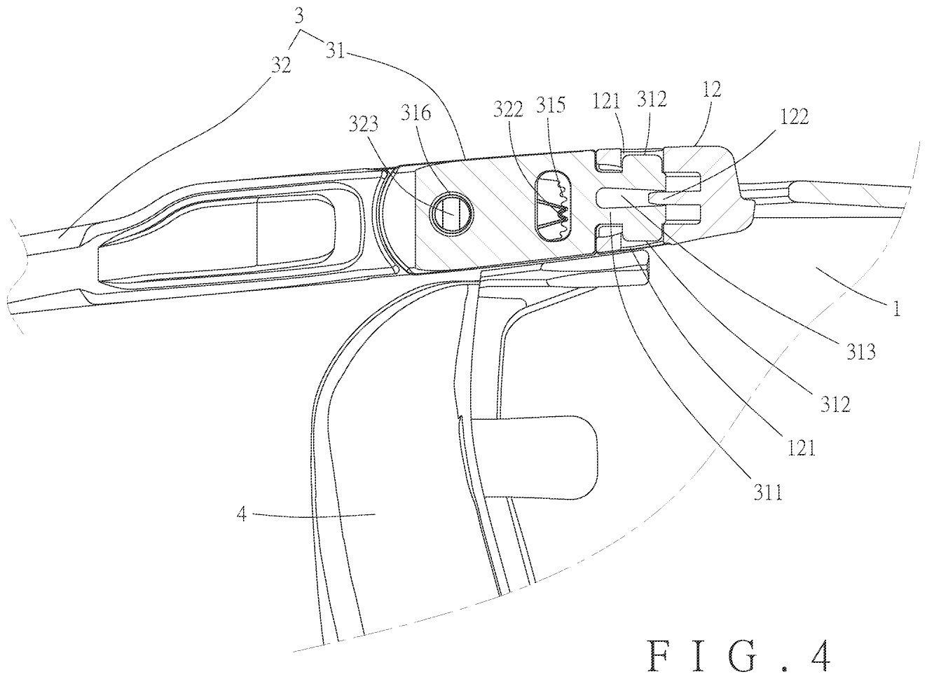

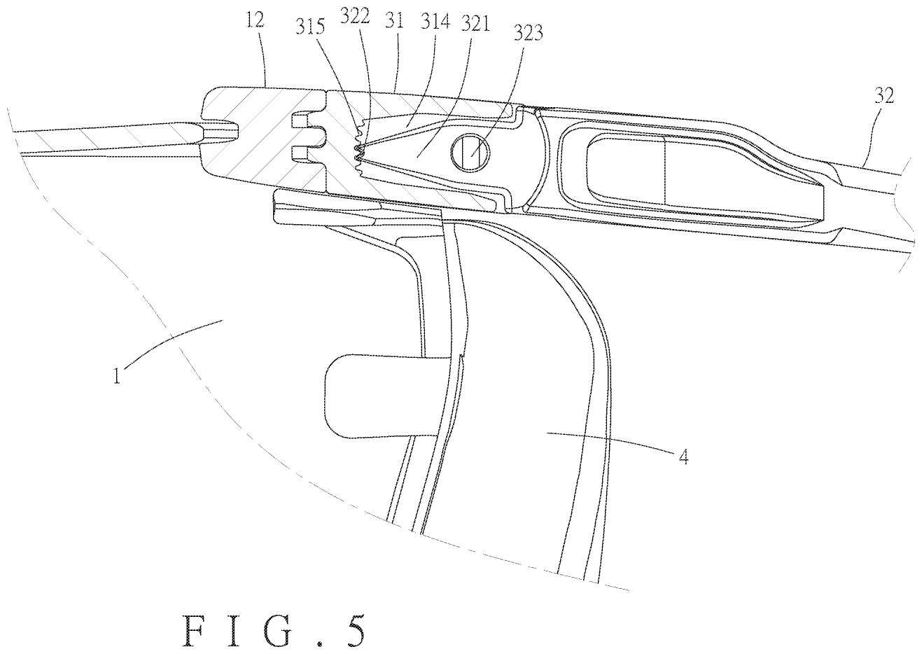

The two temple units 3 are each coupled to the corresponding one of the first coupling portions 12 on the two lateral sides of the first lens 1. Each temple unit 3 includes an adapter block 31 and a temple 32. Each adapter block 31 is provided with a second coupling portion 311 at one end, and each second coupling portion 311 has an upper side and a lower side each provided with a first engaging block 312 along the vertical direction Y. The two first engaging blocks 312 of each second coupling portion 311 are each engaged in the corresponding one of the two first engaging holes 121 of the corresponding first coupling portion 12 (see FIG. 4) so that each adapter block 31 can be rotated to the left and to the right with respect to the first lens 1. Each second coupling portion 311 further has a middle portion provided with a groove 313, and the groove 313 of each second coupling portion 311 is configured to receive and confine the protruding plate 122 of the corresponding first coupling portion 12, lest the two first engaging blocks 312 of the second coupling portion 311 move out of the two first engaging holes 121 of the corresponding first coupling portion 12 and thereby cause separation between the second coupling portion 311 and the corresponding first coupling portion 12. The opposite end of each adapter block 31 is provided with an insertion groove 314. Each insertion groove 314 is provided therein with a toothed rack section 315 along the vertical direction Y, and each insertion groove 314 has two lateral walls each provided with a second engaging hole 316 along a horizontal direction X. Each temple 32 is provided with an insertion plate 321 at one end, and the insertion plate 321 of each temple 32 is inserted into the insertion groove 314 of the corresponding adapter block 31 such that the temple 32 is limited in position while being allowed to rotate. More specifically, each insertion plate 321 has an end portion provided with a toothed block 322 meshing with the toothed rack section 315 of the corresponding insertion groove 314 (see FIG. 5), each insertion plate 321 further has two lateral sides each provided with a second engaging block 323 along the horizontal direction X, and each of the two second engaging blocks 323 of each insertion plate 321 is engaged in the corresponding second engaging hole 316 of the corresponding insertion groove 314 so that each temple 32 can be rotated upward and downward with respect to the corresponding adapter block 31. The first lens 1 and the temple units 3 are made of plastic, are put together by engagement between corresponding structures, and therefore need not be held together by metal screws or elastic elements. This makes it possible to achieve a lightweight design in which the assembled goggles weigh less than goggles using metal screws or elastic elements. More importantly, electrical hazards associated with the use of metal screws or elastic elements are also eliminated to reduce occupational safety accidents attributable to the conduction of electricity, thereby ensuring the highest safety of use.

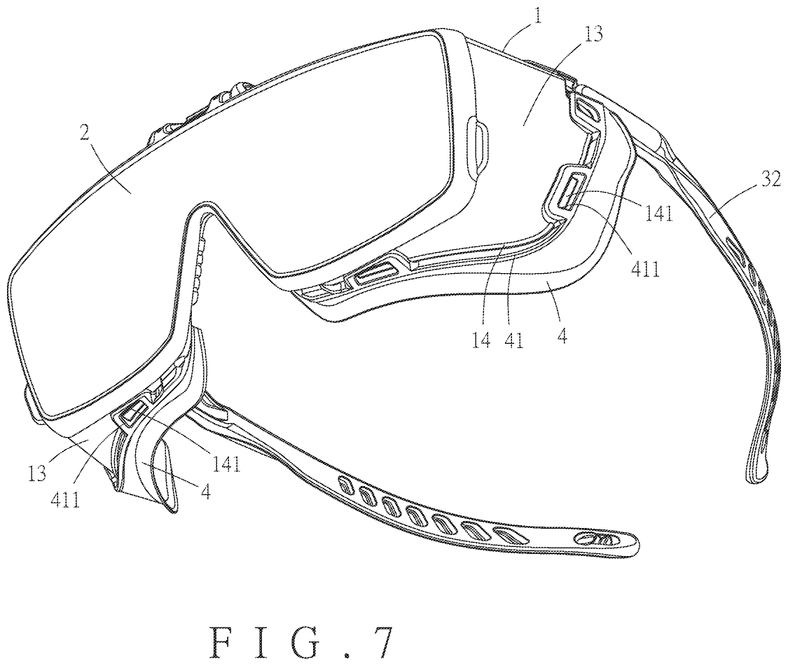

The two soft sealing pads 4 are coupled to the first lens 1 in a detachable manner (see FIG. 6 and FIG. 7). Each soft sealing pad 4 is provided with a second snap-fit portion 41 along a lateral side and a bottom portion of the soft sealing pad 4, and each second snap-fit portion 41 is provided with a plurality of snap-fit holes 411. Each second snap-fit portion 41 is configured to form a snap-fit connection with the corresponding first snap-fit portion 14, with each snap-fit block 141 snap-fitted in the corresponding snap-fit hole 411 such that the soft sealing pads 4 are detachably coupled to the lateral sides and the corresponding bottom portions of the first lens 1.

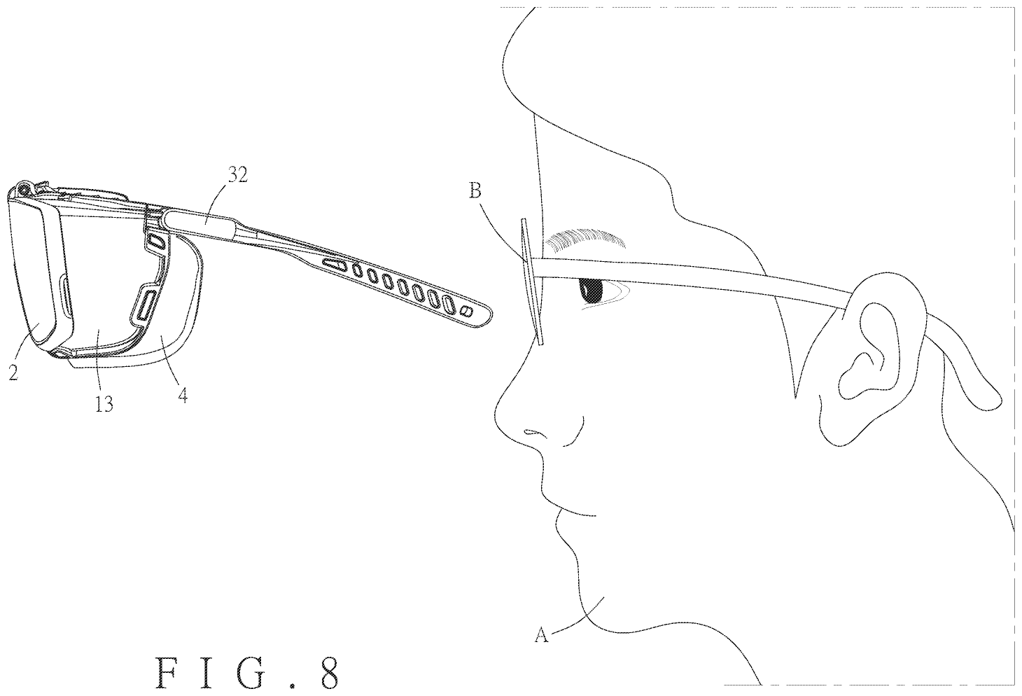

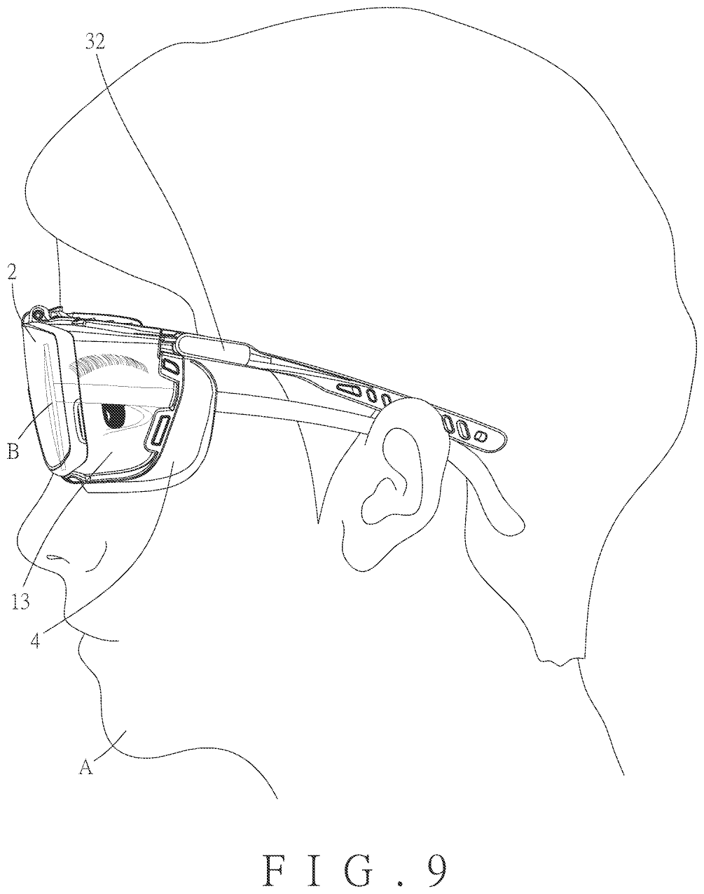

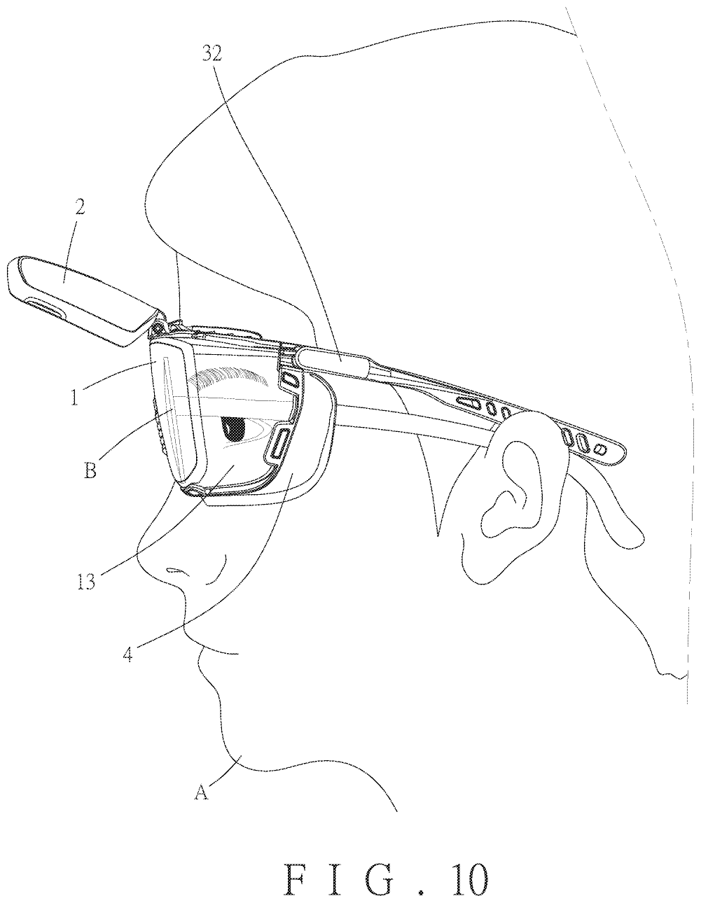

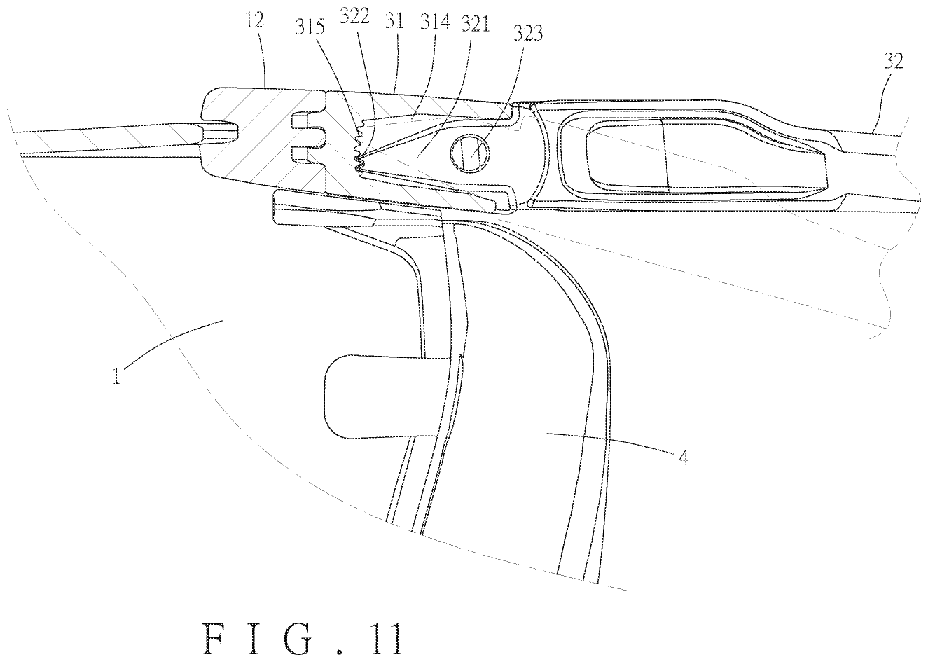

Referring to FIG. 8 and FIG. 9 in conjunction with FIG. 1 and FIG. 3, when it is necessary for a user A to wear a pair of eyeglasses B and the goggles during work or a certain activity, the relatively large accommodating space 15 on the inner side of the first lens 1 can accommodate the eyeglasses B regardless of the size of their eyeglass frame as long as the frame is a common one, with the first lens 1 covering the eyeglasses B. Moreover, referring to FIG. 10, the second lens 2 can be flipped open with respect to the first lens 1 according to practical needs. Furthermore, referring to FIG. 11 in conjunction with FIG. 5, the goggles can be adjusted according to the size of the user A's face by rotating the temples 32 upward or downward with respect to the adapter blocks 31. With each toothed block 322 meshing with, slidable along, and stoppable at any tooth position of, the corresponding toothed rack section 315, the temples 32 can be rotated in stages with respect to the adapter blocks 31 and then held in place without further rotation. So, by vertically rotating, and thereby adjusting the positions of, the two temple units 3 with respect to the two lateral sides of the first lens 1, the goggles can be adapted to the shape of the user A's face and then worn on the face without getting loose or falling off.

As shown in FIG. 6, FIG. 7, and FIG. 8, the soft sealing pads 4 are configured to be in close contact with those areas of the user A's face that are on the outer lateral sides of, and below, the eyes in order to keep foreign objects from flying into the goggles while the user A is working, or prevent a patient's body fluid, bacteria, or virus from reaching the user A's eyes through a gap between the goggles and the user A's face while the user A is performing a medical operation, the objective being to preclude injury in an industrial environment or infection in a medical environment. The goggles, therefore, are particularly suitable for providing protection in a medical or industrial environment. The softness of the two soft sealing pads 4 also adds to the comfort of wear, the tightness of wear, and the anti-slip effect of the goggles so that the goggles can be worn for a long time without causing discomfort or becoming a burden.

With continued reference to FIG. 6 and FIG. 7, the two soft sealing pads 4, which are detachably coupled to the first lens 1, can be removed when no longer needed. To remove the two soft sealing pads 4, each snap-fit block 141 is forced out of the corresponding snap-fit hole 411 so that each second snap-fit portion 41 can be separated from the corresponding first snap-fit portion 14. Removal of the soft sealing pads 4 helps increase ventilation in the goggles while the goggles are being worn; that is to say, the goggles will not be fogged up with hot air and become blurred even if worn for an extended period of time or under a high temperature. This is an improvement over those conventional goggles whose closed lateral portions cannot be removed to improve ventilation.

Referring to FIG. 1, FIG. 2, and FIG. 8, the lateral window portions 13 on the left and right sides of the first lens 1 are transparent such that the see-through area of the first lens 1 is extended on the two lateral sides. When wearing the goggles during work or other activities, therefore, the user A will be able to have a large field of view, without the goggles hindering the work or activities; consequently, the safety of use is ensured. Moreover, the user A no longer has to turn their head to the left or right during work or other activities as is conventionally required when the frame of a pair of goggles narrows the user's field of view on the left and right sides. In other words, the goggle structure of the present invention provides greater convenience of use than their prior art counterparts.

The above description of an embodiment of the present invention should be able to shed sufficient light on the operation, use, and intended effects of the invention. The disclosed embodiment, however, is only a preferred one of the invention and is not intended to be restrictive of the scope of the invention. Any simple equivalent change or modification based on the appended claims and the contents of this specification should be viewed as falling within the scope of the invention.

What is claimed is:

1. A goggle structure having a flip-up function and capable of covering eyeglasses, comprising:
a first lens provided with a first pivotal connection portion, wherein the first lens has two lateral sides each provided with a first coupling portion, each of the two lateral sides of the first lens is extended with a transparent lateral window portion, each said lateral window portion is provided with a first snap-fit portion, and the first lens has an inner side defining an accommodating space;
a second lens provided with a second pivotal connection portion, wherein the second pivotal connection portion is pivotally connected to the first pivotal connection portion such that the second lens is able to be flipped open with respect to the first lens;
two temple units each coupled to a corresponding one of the two lateral sides of the first lens, wherein each said temple unit comprises an adapter block and a temple, each said adapter block has an end provided with a second coupling portion for coupling with a corresponding one of the first coupling portions such that each said adapter block is rotatable leftward and rightward with respect to the first lens, each said adapter block has an opposite end provided with an insertion groove, each said temple has an end provided with an insertion plate, and the insertion plate of each said temple is inserted into the insertion groove of a corresponding one of the adapter blocks to produce a position-limiting effect while allowing each said temple to be rotated upward and downward with respect to the corresponding one of the adapter blocks; and
two soft sealing pads detachably coupled to the first lens, wherein each said soft sealing pad is provided with a second snap-fit portion for forming a snap-fit connection with a corresponding one of the first snap-fit portions.

2. The goggle structure having a flip-up function and capable of covering eyeglasses as claimed in claim 1, wherein the first lens has a middle portion provided with the first pivotal connection portion, and the second lens has a middle portion provided with the second pivotal connection portion.

3. The goggle structure having a flip-up function and capable of covering eyeglasses as claimed in claim 1, wherein each said first coupling portion has an upper side and a lower side each provided with a first engaging hole along a vertical direction, and each said second coupling portion has an upper side and a lower side each provided with a first engaging block along the vertical direction, and the two first engaging blocks of each said second coupling portion are each engaged in a corresponding one of the two first engaging holes of the corresponding one of the first coupling portions.

4. The goggle structure having a flip-up function and capable of covering eyeglasses as claimed in claim 3, wherein each said first coupling portion is provided with a protruding plate between the two first engaging holes of the each said first coupling portion, and each said second coupling portion has a middle portion provided with a groove for receiving and confining the protruding plate of the corresponding one of the first coupling portions.

5. The goggle structure having a flip-up function and capable of covering eyeglasses as claimed in claim 1, wherein each said first snap-fit portion is provided with a plurality of snap-fit blocks, each said second snap-fit portion is provided with a plurality of snap-fit holes, and the snap-fit blocks of each said first snap-fit portion are each snap-fitted in a corresponding one of the snap-fit holes of the corresponding one of the first snap-fit portions.

6. The goggle structure having a flip-up function and capable of covering eyeglasses as claimed in claim 1, wherein the first lens and the temple units are made of plastic, are put together by engagement between corresponding structures, and therefore need not be held together by metal screws or elastic elements.

7. The goggle structure having a flip-up function and capable of covering eyeglasses as claimed in claim 1, wherein the second lens is a protective lens for use in a medical environment, an eye-protecting lens for use in an industrial environment, a sun-blocking lens, a lens for vision correction, or a sports lens for use in a sports activity, and the accommodating space is configured to accommodate a pair of eyeglasses such that the pair of eyeglasses is covered by the first lens.

8. The goggle structure having a flip-up function and capable of covering eyeglasses as claimed in claim 1, wherein each said insertion groove has two lateral walls each provided with a second engaging hole along a horizontal direction, and each said insertion plate has two lateral sides each provided with a second engaging block along the horizontal direction, and the second engaging blocks of each said insertion plate are each engaged in a corresponding one of the second engaging holes of a corresponding one of the insertion grooves.

9. The goggle structure having a flip-up function and capable of covering eyeglasses as claimed in claim 1, wherein each said insertion groove is provided therein with a toothed rack section along a vertical direction, each said insertion plate has an end portion provided with a toothed block, and the toothed block of each said insertion plate meshes with the toothed rack section of a corresponding one of the insertion grooves.

10. The goggle structure having a flip-up function and capable of covering eyeglasses as claimed in claim 1, wherein each said first snap-fit portion is provided on a lateral side and a bottom portion of a corresponding one of the lateral window portions, and each said second snap-fit portion is provided on a lateral side and a bottom portion of a corresponding one of the soft sealing pads.
